(19) United States
(12) Patent Application Publication
(10) Pub. No.: US 2026/0121338 A1
(43) Pub. Date: Apr. 30, 2026

(54) CABLE CONNECTION RETAINER APPARATUS

(71) Applicant: Hill-Rom Services, Inc., Batesville, IN (US)

(72) Inventors: THIERRY JAFFRE, Pluvigner (FR); STEPHANE FRAYSSINET, Saint Pierre Quiberon (FR); MATTHIEU GUETTA, Pluvigner (FR); MATHIEU BERNARD, Plumergat (FR); PHILIPPE LEGROS, Pluneret (FR)

(21) Appl. No.: 19/371,909

(22) Filed: Oct. 28, 2025

Related U.S. Application Data
(60) Provisional application No. 63/713,726, filed on Oct. 30, 2024.

(51) Int. Cl. H01R 13/518; H01R 13/52; H01R 13/639

(52) U.S. Cl. CPC H01R 13/518; H01R 13/5205; H01R 13/639; H01R 2201/12

(57) ABSTRACT

This disclosure relates to devices and methods that can increase the efficiency of patient support apparatus. A connecting device comprises an insert component that is configured to be insertable into a sleeve component. The sleeve component comprises a sleeve surface wall enclosing a sleeve open space extending from a first sleeve end to a second sleeve end and including a sleeve receiving cap on the second sleeve end with a first access port. The insert component comprises an insert surface wall enclosing an insert open space extending from a first insert end to a second insert end and including an insert receiving cap on the first insert end with a second access port. The sleeve component is attached to the insert component by a connector passing through the first and second access ports.

### CROSS-REFERENCE TO RELATED APPLICATIONS

This nonprovisional applications claims the benefit and priority, under 35 U.S.C. § 119 (e) and any other applicable laws or statues, to U.S. Provisional Patent Application Ser. No. 63/713,726 filed on Oct. 30, 2024, the entire disclosure of which is hereby expressly incorporated herein by reference

### BACKGROUND

The present disclosure relates to the use of systems and methods to improve patient care by optimizing use and efficiency of patient support apparatus. More specifically, the present disclosure is related to systems and methods to prevent the stoppage and use of patient apparatus due to cable disconnection.

While cable connections are easy to establish, they can be easily unplugged. Too often, a light and/or continuous pull or movement can disconnect the cables and stop the patient support apparatus from functioning. The unplugging of cables may not be noticed by caregivers resulting in sub-optimal patient care. Therefore, there is a need to prevent cables attached to patient support apparatus and/or other devices used in patient care from easily disconnecting.

Modular manufacturability and assembly of such connecting devices can help in improving the efficiency of the patient support apparatus.

This disclosure relates to accessories for patient support apparatus. Specifically, this disclosure relates to devices and methods that can be used to prevent electrical disconnects in apparatus used in health care systems.

### SUMMARY

The present disclosure includes one or more of the features recited in the appended claims and/or the following features which, alone or in any combination, may comprise patentable subject matter.

According to a first aspect, the present disclosure is directed to a connecting device for connecting a pair of electrical cables, comprising a sleeve component and an insert component. The sleeve component comprises a sleeve surface wall enclosing a sleeve open space extending from a first sleeve end to a second sleeve end, the sleeve component further including a sleeve receiving cap on the second sleeve end with a first access port. The insert component comprises an insert surface wall enclosing an insert open space extending from a first insert end to a second insert end, the insert component further including an insert receiving cap on the first insert end with a second access port. The second insert end of the insert component is configured to be insertable into the second sleeve end of the sleeve component, forming an interface between the insert surface wall and the sleeve surface wall. The sleeve receiving cap and the insert receiving cap are aligned along a longitudinal axis of the connecting device when the insert component is inserted into the sleeve component. The sleeve component is attached to the insert component by a connector passing through the first and second access ports.

In some embodiments of the first aspect, the first sleeve end may have a first opening with a first diameter smaller than a second diameter of a second opening at the second sleeve end.

In some embodiments of the first aspect, the first insert end may have a first opening with a first diameter smaller than a second diameter of a second opening at the second insert end.

In some embodiments of the first aspect, the second sleeve end may have a first opening with a first diameter larger than a second diameter of a second opening at the second insert end. In some embodiments of the first aspect, the insert component may be configured to be interlocking with the sleeve component.

In some embodiments of the first aspect, the connector may be a screw, a clip, a strap, or a colson.

In some embodiments of the first aspect, the interface of the connecting device formed between the insert surface wall and the sleeve surface wall may be watertight.

In some embodiments of the first aspect, the connecting device may be configured to prevent water or dust ingress into the sleeve open space and the insert open space.

In some embodiments of the first aspect, the sleeve open space may be configured to house a first cable, and the insert open space is configured to house a second cable attachable to the first cable. In some embodiments of the first aspect, the first cable may form a watertight interface with the sleeve surface wall at a first opening at the first sleeve end. In some embodiments of the first aspect, the second cable may form a watertight interface with the insert surface wall at a first opening at the first insert end.

In some embodiments of the first aspect, the connecting device may be configured to be used with a plurality of cables, each of the cables is comprised of a different size.

According to a second aspect, the present disclosure is directed to a connecting device for connecting a pair of electrical cables, comprising a sleeve component and an insert component. The sleeve component comprises a sleeve surface wall enclosing a sleeve open space extending from a first sleeve end to a second sleeve end, and a first access port at the second sleeve end. The insert component comprises an insert surface wall enclosing an insert open space extending from a first insert end to a second insert end, and a second access port at the first insert end. The sleeve component is attached to the insert component by a connector passing through the first and second access ports.

In some embodiments of the second aspect, the first sleeve end may have a first opening with a first diameter smaller than a second diameter of a second opening at the second sleeve end.

In some embodiments of the second aspect, the first insert end may have a first opening with a first diameter smaller than a second diameter of a second opening at the second insert end.

In some embodiments of the second aspect, the second sleeve end may have a first opening with a first diameter larger than a second diameter of a second opening at the second insert end. In some embodiments of the second aspect, the insert component may be configured to be interlocking with the sleeve component.

In some embodiments of the second aspect, the connector may be a screw, a clip, a strap, or a colson.

In some embodiments of the second aspect, the insert component may be configured to be insertable into the sleeve component, forming a watertight interface between the insert surface wall and the sleeve surface wall.

In some embodiments of the second aspect, the connecting device may be configured to prevent water or dust ingress into the sleeve open space and the insert open space.

In some embodiments of the second aspect, the sleeve open space may be configured to house a first cable, and the insert open space is configured to house a second cable attached to the first cable. In some embodiments of the second aspect, the first cable may form a watertight interface with the sleeve surface wall at a first opening at the first sleeve end. In some embodiments of the second aspect, the second cable may form a watertight interface with the insert surface wall at a first opening at the first insert end.

In some embodiments of the second aspect, the connecting device may be configured to be used with a plurality of cables, each of the cables is comprised of a different size.

According to a third aspect, the present disclosure is directed to a method of connecting cables comprising passing a first cable into a sleeve open space of a sleeve component of a connecting device, wherein the first cable forms a first interface with a sleeve surface wall of the sleeve component, passing a second cable into an insert open space of an insert component of the connecting device, wherein the second cable forms a second interface with an insert surface wall of the insert component, attaching the first cable to the second cable, sliding the insert component into the sleeve open space of the sleeve component, and connecting the sleeve component to the insert component with a connector passing through a first access port located on the sleeve component and a second access port located on the insert component.

In some embodiments of the third aspect, the sleeve component may comprise a sleeve surface wall enclosing the sleeve open space extending from a first sleeve end to a second sleeve end of the sleeve component and the insert component comprises an insert surface wall enclosing an insert open space extending from an insert first end to an insert second end of the insert component.

In some embodiments of the third aspect, the first access port may be located on a sleeve receiving cap on the second sleeve end of the sleeve component and the second access port is located on an insert receiving cap on the first insert end of the insert component, and wherein the sleeve receiving cap and the insert receiving cap are aligned along a longitudinal axis of the connecting device when the insert component is inserted into the sleeve component.

In some embodiments of the third aspect, the first sleeve end may have a first opening with a first diameter smaller than a second diameter of a second opening at the second sleeve end.

In some embodiments of the third aspect, the first insert end may have a first opening with a first diameter smaller than a second diameter of a second opening at the second insert end.

In some embodiments of the third aspect, the second sleeve end may have a first opening with a first diameter larger than a second diameter of a second opening at the second insert end. In some embodiments of the third aspect, the insert component may be configured to be interlocking with the sleeve component.

In some embodiments of the third aspect, the connector may be a screw, a clip, a strap, or a colson.

In some embodiments of the third aspect, connecting device may be configured to prevent dust ingress into the sleeve open space and the insert open space.

In some embodiments of the third aspect, the first cable may form a watertight interface with the sleeve surface wall at a first opening at the first sleeve end. In some embodiments of the third aspect, the second cable may form a watertight interface with the insert surface wall at a first opening at the first insert end.

In some embodiments of the third aspect, the connecting device may be configured to be used with a plurality of cables, each of the cables is comprised of a different size.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of an embodiment of a connecting device configured to be attached to each other with a strap;

FIG. 2 is a cross-sectional view of the connecting device illustrated in FIG. 1;

FIG. 3 is a perspective view of an embodiment of a connecting device configured to be attached to each other with a screw;

FIG. 4A is a schematic illustrating the connecting device and the two cables;

FIG. 4B is a schematic illustrating a first cable being inserted into the open space of a sleeve section of the connecting device and a second cable being inserted into the open space of the connecting device.

FIG. 4C is a schematic illustrating the first cable attached to the second cable and the insert section positioned in the open space of the sleeve section.

FIG. 4D is a schematic illustrating a strap connecting the sleeve section to the insert section.

FIG. 5A is a schematic of a top view of an embodiment of a sleeve section of the connecting device;

FIG. 5B is a schematic of a top view of a first end of the sleeve section of the connecting device;

FIG. 5C is a schematic of a side view of the sleeve section of the connecting device;

FIG. 5D is a schematic of a top view of a second end of the sleeve section of the connecting device;

FIG. 5E is a schematic of a cross-sectional view along plane A-A′ of the sleeve section illustrated in FIG. 5C;

FIG. 6A is a schematic of a top view of an embodiment of an insert section of the connecting device;

FIG. 6B is a schematic of a top view of a first end of the insert section of the connecting device;

FIG. 6C is a schematic of a side view of the insert section of the connecting device;

FIG. 6D is a schematic of a top view of a second end of the insert section of the connecting device;

FIG. 6E is a schematic of a cross-sectional view along plane B-B′ of the insert section illustrated in FIG. 6C; and

FIG. 6F is a schematic of a cross-sectional view along plane C-C′ of the insert section illustrated in FIG. 6B;

### DETAILED DESCRIPTION

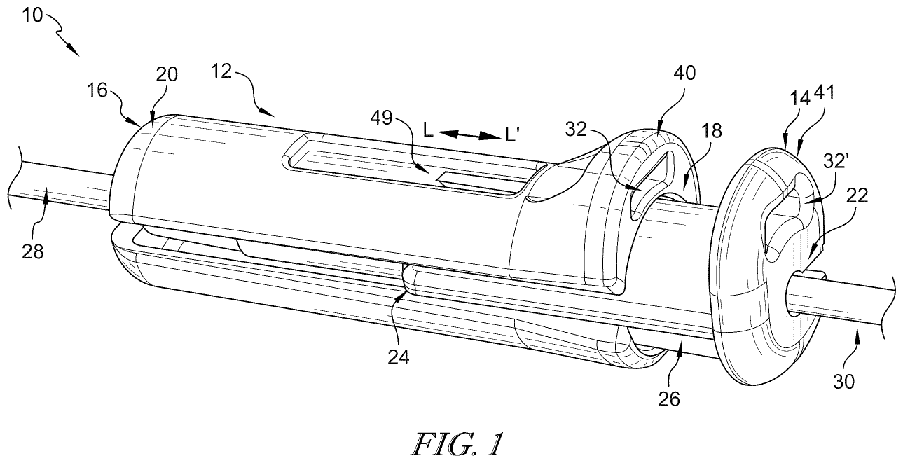

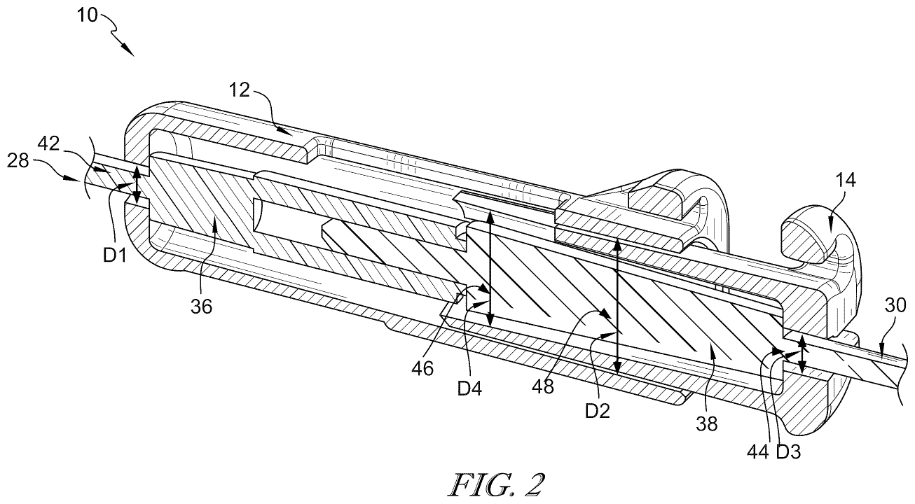

According to the present disclosure, a connecting device 10 comprises a first section or a sleeve section 12, and a second section or an insert section 14 as shown in FIG. 1. FIG. 2 is a cross-section view of the connecting device 10 along a longitudinal axis L-L′ shown in FIG. 1. The sleeve section 12 further comprises a first end 16, a second end 18, and a sleeve surface wall 20 extending from the first end 16 to the second end 18 and enclosing an open space 36. The first end 16 of the sleeve section 12 has an opening 42 with diameter D1 and the second end 18 of the first sleeve section 12 has an opening 48 with a diameter D2. The insert section 14 further comprises a first end 22, a second end 24, and an insert surface wall 26 extending from the first end 22 to the second end 24 and enclosing an open space 38. The first end 22 of the insert section 14 has an opening 44 with a diameter D3 and the second end 24 of the insert section 14 has an opening 46 with a diameter D4. The diameter D1 may be different than the diameter D2 of the sleeve section 12. The diameter D3 may be different than the diameter D4 of the insert section 14. The diameter D3 of the of the insert section 14 is smaller than the diameter D2 of the sleeve section 12 such that the insert section 14 can slide into the sleeve section 12.

The sleeve section 12 and insert section 14 are configured to enable a cable to enter the open spaces 36, 38 through openings 42 and 44 respectively. As illustrated in FIGS. 1 and 2, a cable 28 enters the open space 36 through the first end 16 of the sleeve section 12. Similarly, a cable 30, which can be connected to the cable 28, enters the open space 38 through the first end 22 of the insert section 14. The cables 28 and 30 are connected or locked inside the device 10. The insert section 14 can slide into the sleeve section 12 such that the interface between the sleeve surface wall 20 and the insert surface wall 26 is airtight and/or watertight. The interface between the sleeve surface wall 20 and the cable 28 at the opening 42 and the interface between the insert surface wall 26 and the cable 30 at the opening 44 is airtight and/or watertight. A watertight opening prevents the ingress of water into the open spaces 36, 38. An airtight opening prevents the ingress of dust and/or steam into the open spaces 36, 38. The connective device 10 may include one or more rings to prevent water, dust, and/or steam ingress. The cables 28, 30 inside the connective device 10 are also protected from damage due to impact.

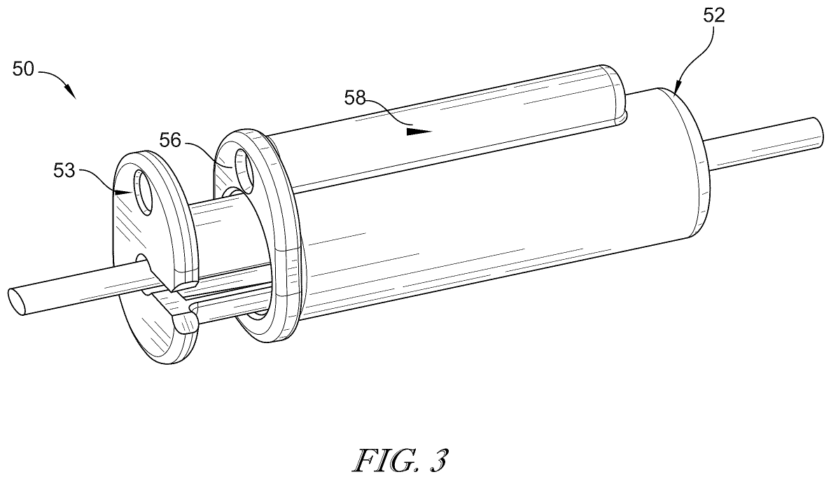

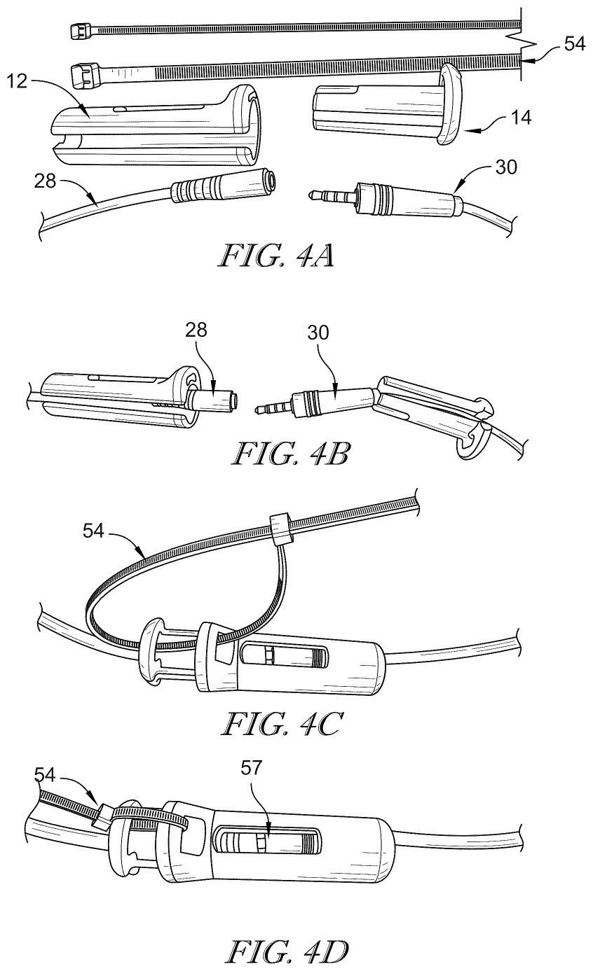

The sleeve section 12 and insert section 14 can be connected or attached to each other with a connector. The connector may be a screw, a clip, a strap, or a colson. FIG. 1 illustrates a connecting device 10 that includes a sleeve section 12 and insert section 14 that are configured to be attached via a strap 54 (shown in FIG. 4A-D). The sleeve section 12 includes a receiving cap 40 at the second end 18 that has an access port 32. The insert section 14 includes a receiving cap 41 at the first end 22 that has an access ports 32′. The receiving caps 40, 41 are aligned along a longitudinal axis L-L′ such that the access ports 32, 32′ are aligned generally above each other. A strap 54 can be passed through the access ports 32, 32′ to attach the two components 12, 14. FIG. 3 illustrates a connecting device 50 that includes a sleeve section 52 and insert section 53 that are configured to be attached via a screw (not shown). The screw can pass through the sleeve section 52 and the insert section 53 via screw holes 56 into a screw chamber 58.

FIGS. 4A-4D illustrate the steps that are implemented in using the connecting device 10 shown in FIG. 1 for connecting two cables 28 and 30. FIG. 4A shows the two components, the sleeve section 12 and the insert section 14, the strap 54 that is used to connect the sleeve section 12 and the insert section 14, and the cables 28, 30. FIG. 4B shows the cable 28 being inserted into the open space 36 of the sleeve section 12 and the cable 30 being inserted into the open space 38 of the insert section 14. FIG. 4C shows the cable 28 being attached to the cable 30 and the insert section 14 sliding into the open space 36 of the sleeve section 12. FIG. 4D shows the strap 54 connecting the sleeve section 12 to the insert section 14. The sleeve section 12 includes a window 57 through which the cable 28, 30 can be visualized.

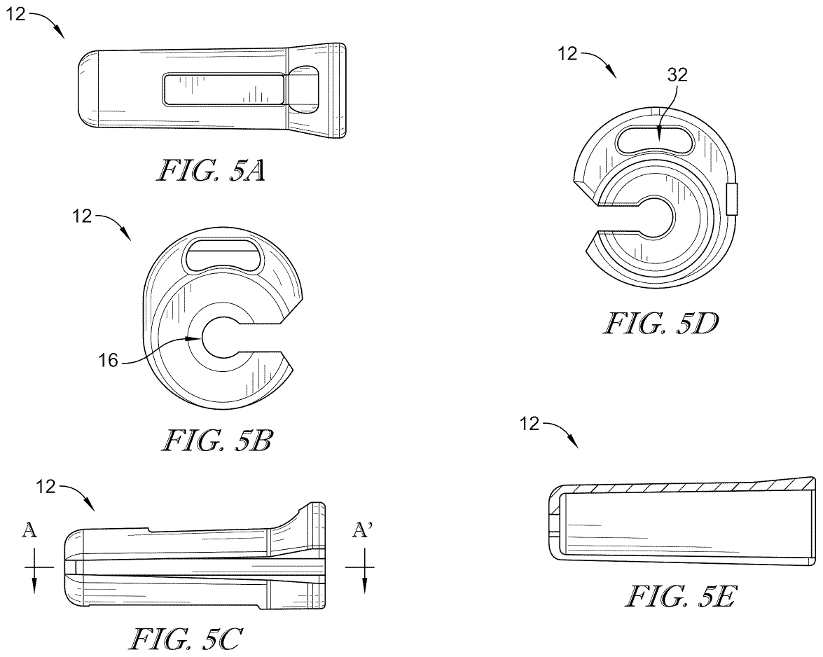

FIG. 5A-E illustrates an exemplified embodiment of the sleeve section 12 of the connecting device 10. The length of the sleeve section 12 can vary depending on the application. FIG. 5A illustrates a top view of one embodiment, where the length of the sleeve section 12 is about 56.5 mm. FIG. 5C illustrates a side view of the sleeve section 12. The cable 28 exits the sleeve section 12 through the second end 18. The diameter (D1) of the first end 16 can vary depending on the application. FIG. 5B illustrates one embodiment, where the radius of the first end 16 of is about 2.3 mm. The width of the access ports 32 can vary depending on the application. FIG. 5D illustrates one embodiment, where the width of the access port 32 at the second end 18 is about 2 mm. FIG. 5E illustrates a cross section along the plane A-A′ of the embodiment of the sleeve section 12 shown in FIG. 5C.

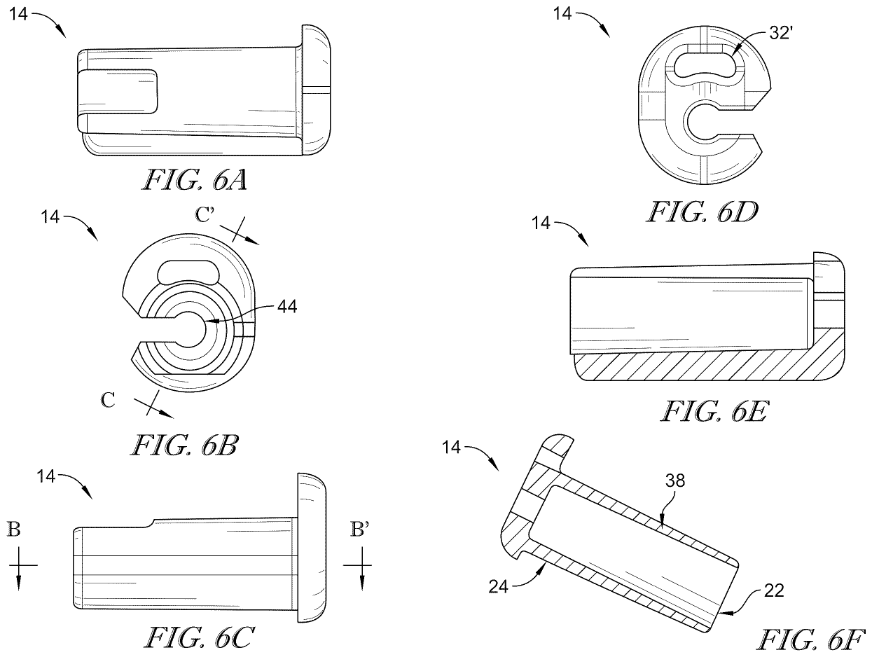

FIG. 6A-F illustrates an exemplified embodiment of the insert section 14 of the connecting device 10. The length of the insert section 14 can vary depending on the application. FIG. 6A illustrates one embodiment, where the length of the insert section 14 is about 39.4 mm. The cable 30 exits the insert section 14 through the second end 24. The diameter (D4) of the second end 24 can vary depending on the application. FIGS. 6B-6C illustrate one embodiment, where the radius of the second end 24 is about 2.3 mm. The width or the access ports 32′ can vary depending on the application. FIG. 6D illustrates one embodiment, where the width of the access port 32′ is about 2.8 mm. FIG. 6E illustrates a cross section along the plane B-B′ of the embodiment of the insert section 14 shown in FIG. 6C. FIG. 6F illustrates a cross section along the plane C-C′ of the embodiment of the insert section 14 shown in FIG. 6B. The open space 38 has a tapering diameter as it extends from the second end 24 to the first end 22 in the insert section 14 (FIG. 6F).

The connecting device 10 may be comprised of plastic. The connecting device 10 may be manufactured by injection molding, 3D printing, die trimming, or any other method than can be used with plastics and polymers. The connecting device 10 may be designed to be used with cables of varying sizes and with different types of apparatuses used in healthcare systems.

Although this disclosure refers to specific embodiments, the disclosure is not limited to the disclosed embodiments. It will be understood by those skilled in the art that various changes in form and detail can be made without departing from the subject matter set forth in the accompanying claims. For example, the disclosure has been illustrated and described in detail in the drawings and the foregoing description, such illustration and description are to be considered illustrative or exemplary and not restrictive. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

1. A connecting device for connecting a pair of electrical cables, comprising:
a sleeve component with a sleeve surface wall enclosing a sleeve open space extending from a first sleeve end to a second sleeve end, the sleeve component further including a sleeve receiving cap on the second sleeve end with a first access port,
an insert component with an insert surface wall enclosing an insert open space extending from a first insert end to a second insert end, the insert component further including an insert receiving cap on the first insert end with a second access port,
wherein the second insert end of the insert component is configured to be insertable into the second sleeve end of the sleeve component, forming an interface between the insert surface wall and the sleeve surface wall, wherein the sleeve receiving cap and the insert receiving cap are aligned along a longitudinal axis of the connecting device when the insert component is inserted into the sleeve component, and wherein the sleeve component is attached to the insert component by a connector passing through the first access port and the second access port.

2. The connecting device of claim 1, wherein the first sleeve end has a first opening with a first diameter smaller than a second diameter of a second opening at the second sleeve end.

3. The connecting device of claim 1, wherein the first insert end has a first opening with a first diameter smaller than a second diameter of a second opening at the second insert end.

4. The connecting device of claim 1, wherein the second sleeve end has a first opening with a first diameter larger than a second diameter of a second opening at the second insert end.

5. The connecting device of claim 4, wherein the insert component is configured to be interlocking with the sleeve component.

6. The connecting device of claim 1, wherein the connector is a screw, a clip, a strap, or a colson.

7. The connecting device of claim 1, wherein the interface of the connecting device formed between the insert surface wall and the sleeve surface wall is watertight.

8. The connecting device of claim 1, wherein the connecting device is configured to prevent water or dust ingress into the sleeve open space and the insert open space.

9. The connecting device of claim 1, wherein the sleeve open space is configured to house a first cable and the insert open space is configured to house a second cable attachable to the first cable.

10. The connecting device of claim 9, wherein the first cable is configured to form a watertight interface with the sleeve surface wall at a first opening at the first sleeve end.

11. A connecting device for connecting a pair of electrical cables, comprising:
a sleeve component with a sleeve surface wall enclosing a sleeve open space extending from a first sleeve end to a second sleeve end, the sleeve component further including a first access port at the second sleeve end,
an insert component with an insert surface wall enclosing an insert open space extending from a first insert end to a second insert end, the insert component further including a second access port at the first insert end,
wherein the sleeve component is attached to the insert component by a connector passing through the first access port and the second access port.

12. The connecting device of claim 11, wherein the first sleeve end has a first opening with a first diameter smaller than a second diameter of a second opening at the second sleeve end.

13. The connecting device of claim 11, wherein the first insert end has a first opening with a first diameter smaller than a second diameter of a second opening at the second insert end.

14. The connecting device of claim 11, wherein the second sleeve end has a first opening with a first diameter larger than a second diameter of a second opening at the second insert end.

15. The connecting device of claim 14, wherein the insert component is configured to be interlocking with the sleeve component.

16. The connecting device of claim 11, wherein the connector is a screw, a clip, a strap, or a colson.

17. A method of connecting cables, the method comprising:
passing a first cable into a sleeve open space of a sleeve component of a connecting device, wherein the first cable is configured to form a first interface with a sleeve surface wall of the sleeve component,
passing a second cable into an insert open space of an insert component of the connecting device, wherein the second cable is configured to form a second interface with an insert surface wall of the insert component,
attaching the first cable to the second cable, sliding the insert component into the sleeve open space of the sleeve component, and
connecting the sleeve component to the insert component with a connector passing through a first access port located on the sleeve component and a second access port located on the insert component.

18. The method of claim 17, wherein the sleeve component comprises the sleeve surface wall enclosing the sleeve open space extending from a first sleeve end to a second sleeve end of the sleeve component and the insert component comprises the insert surface wall enclosing the insert open space extending from an insert first end to an insert second end of the insert component.

19. The method of claim 18, wherein the first access port is located on a sleeve receiving cap on the second sleeve end of the sleeve component and the second access port is located on an insert receiving cap on a first insert end of the insert component, and wherein the sleeve receiving cap and the insert receiving cap are aligned along a longitudinal axis of the connecting device when the insert component is inserted into the sleeve component.

20. The method of claim 17, wherein the insert component is configured to be interlocking with the sleeve component.
